(19) United States
(12) Patent Application Publication
(10) Pub. No.: US 2026/0158703 A1
(43) Pub. Date: Jun. 11, 2026

(54) HARDENED GYPSUM BODY, AND PREPARATION METHOD THEREFOR AND USE THEREOF

(71) Applicant: Hubei Juhai Environmental Technology Co., Ltd., Wuhan (CN)

(72) Inventor: Zhihao Liu, Wuhan (CN)

(21) Appl. No.: 19/347,046

(22) Filed: Oct. 1, 2025

Related U.S. Application Data
(63) Continuation of application No. PCT/CN2023/114976, filed on Aug. 25, 2023.

(30) Foreign Application Priority Data
Jun. 7, 2023 (CN) 2023106699273

(51) Int. Cl. B28C 5/00; B28C 7/12; C04B 28/14

(52) U.S. Cl. CPC B28C 5/006; B28C 7/126; C04B 28/141; C04B 28/147

(57) ABSTRACT

The present disclosure relates to the technical field of gypsum and provides a hardened gypsum body, and a preparation method therefor and use thereof. The method comprises mixing powdered gypsum, a retarder and water, grinding, and immediately molding to obtain the hardened gypsum body, wherein the total time of the mixing and the grinding is 2-5 min, and the water addition amount during the mixing is 8-30% of the powdered gypsum total mass. The hardened gypsum body prepared by the method has obviously improved mechanical properties and low porosity, and can be used for preparing a mother rock of a lightweight aggregate, a mechanically compression-molded component, a mechanically compression-molded module or a recycled broken stone aggregate. The method greatly expands the application range of the hardened gypsum body, particularly improves the application performance of building gypsum, and is very suitable for preparing high-strength and high-quality phosphogypsum building material products.

### CROSS-REFERENCE TO RELATED APPLICATIONS

The present application claims priority of Chinese Patent Application No. 202310669927.3 filed on Jun. 7, 2023 and entitled “HARDENED GYPSUM BODY, AND PREPARATION METHOD THEREFOR AND USE THEREOF”, and all the disclosure is incorporated herein by reference in its entirety.

### TECHNICAL FIELD

The present disclosure relates to the technical field of gypsum, and particularly relates to a hardened gypsum body, and a preparation method therefor and use thereof.

### BACKGROUND

Hemihydrate gypsum includes α-hemihydrate gypsum (also known as high-strength gypsum) and β-hemihydrate gypsum (also known as building gypsum). A hardened gypsum body is mainly a porous network structure formed by crossing and growing a hydrated new product crystal of the hemihydrate gypsum. The mechanical properties of the hardened body, such as strength, hardness, elastic modulus and the like, are greatly influenced by the porosity in the hardened gypsum body. Generally, the flexural strength and the compressive strength of the material are increased along with the reduction of the porosity, and the porosity is also mainly determined by the composition of the material, particularly the water-gypsum ratio. The theoretical water-gypsum ratio of the hemihydrate gypsum is 18.61%. However, the water consumption required for its actual standard consistency is 65-80%, and is also about 40% even for the high-strength gypsum. Excess water gradually volatilizes out after a gypsum slurry is hardened, leaving many pores in the hardened body, such that the strength is substantially reduced.

In order to reduce the water-gypsum ratio to improve the strength of the hardened gypsum body and solve the problem of softening when the hardened gypsum body meets water, the currently used main means comprise mechanical compression dehydration, additional addition of a water reducing agent and the like. However, the defects of low production efficiency, limited selection of the water reducing agent and the like exist. In addition, there is a technology of increasing the strength of the hardened gypsum body by adding an active material such as silicate cement, high-alumina cement, fly ash, and slag to form a hydraulic substance. But there are also problems of a complex formula, a limited utilization rate of the hemihydrate gypsum, and difficulty in controlling the process. In view of this, the present disclosure is provided.

### SUMMARY

The present disclosure provides a hardened gypsum body, and a preparation method therefor and use thereof, and aims at solving the defects of limited methods for improving the strength of the hardened gypsum body in the prior art, and low production efficiency and difficult process control existing in the current method. The present disclosure redesigns the method for preparing a hardened gypsum body. Specifically, a specific amount of water is added before the gelling property of the hemihydrate gypsum is excited, and mixing and then grinding are performed in the presence of the water. Under the action of the mixing and the grinding, water is gradually and uniformly distributed around hemihydrate gypsum molecules. By controlling the mixing and grinding time and the addition amount of the water, powdered gypsum taking the hemihydrate gypsum as the main component can keep good processing state and homogenization degree so as to be used in the subsequent molding process. The gelling property of the hemihydrate gypsum can be excited by adding little or even no water in the molding stage. The hardened gypsum body prepared by the method is uniform in texture and higher in strength, and the consumption of water can be reduced. In addition, the method has high construction efficiency and wide application range.

Specifically, the present disclosure provides a method for preparing a hardened gypsum body, comprising: mixing powdered gypsum containing hemihydrate gypsum with a mass content of 60% or more and dihydrate gypsum with a content of less than or equal to 5%, a retarder and water to obtain a mixture, grinding the mixture, and immediately molding same after the grinding to obtain the hardened gypsum body, wherein the total time of the mixing and the grinding is 2-5 min, and the addition amount of the water during the mixing is 8-30% of the total mass of the powdered gypsum.

Compared with the existing process for improving the strength of the hardened gypsum body, in the present disclosure, the retarder and the water are added into the powdered gypsum taking the hemihydrate gypsum as the main component for mixing and grinding, the addition amount of the water during the mixing and the mixing and grinding time are controlled, such that the powdered gypsum can keep good processing state and homogenization degree so as to facilitate the subsequent molding process. Particularly, the water is gradually and uniformly distributed around the hemihydrate gypsum molecules, which is very key to the formation of a product with high homogenization degree and high strength in the subsequent molding. The powdered gypsum in the present disclosure is a gypsum product naturally formed or prepared by a specific process, such as byproducts of phosphate industry and some other industries, and the like. The product contains the hemihydrate gypsum with the mass content of 60% or more and the balance being anhydrous gypsum, dihydrate gypsum and other impurity components, wherein the content of the dihydrate gypsum is appropriately less than or equal to 5%.

In the existing method for preparing a hardened gypsum body, water is taken as a necessary raw material for the hydration reaction of the hemihydrate gypsum and is usually added at one time. Besides, the addition amount of the water is far beyond the theoretical water demand of a product (namely dihydrate gypsum) after complete hydration. It is found in practice that reducing a water-gypsum ratio helps to improve the mechanical properties of the hardened gypsum body, such as compressive strength and flexural strength. When the existing technical methods are used, if the addition amount of water is insufficient, the workability of the gypsum during the molding is not satisfied, and instead the gypsum becomes a waste. Based on this, through many experiments, it is found that multiple water addition is beneficial to reducing the water consumption while ensuring the hydration reaction and workability and the like of materials, but fine controls of the multiple water addition and the amount of water added each time are needed, which is not beneficial to the industrial application of the technology. Besides, it is found through further researches that when the retarder and the water are added into the powdered gypsum taking the hemihydrate gypsum as the main component for mixing and grinding, and the water addition amount during the mixing, the grinding time and the time of adding water at the second time are controlled, the total water consumption for converting the powdered gypsum into the hardened gypsum body can be effectively reduced, and the mechanical properties of the obtained hardened gypsum body are significantly improved. In addition, the process parameters in the method are easy to control, and the application range is wider.

The method for preparing a hardened gypsum body provided by the present disclosure comprises: mixing powdered gypsum, a retarder and water to obtain a mixture, grinding the mixture, and immediately adding water for molding after the grinding to obtain the hardened gypsum body, wherein the addition amount of the water during the mixing is 8-22% of the total mass of the powdered gypsum, and the total water consumption from the mixing to the molding is 27-33% of the total mass of the powdered gypsum. If the powdered gypsum contains different components, the water addition amount and the total water consumption during the mixing can be correspondingly adjusted. Generally, when the content of the hemihydrate gypsum in the powdered gypsum is 70% or more, the addition amount of the water during the mixing may be 8-12% of the total mass of the powdered gypsum, and the total water consumption may be 28-33% of the total mass of the powdered gypsum. When the content of the hemihydrate gypsum in the powdered gypsum is 80% or more, the addition amount of the water during the mixing may be 10-13% of the total mass of the powdered gypsum, and the total water consumption may be 28-30% of the total mass of the powdered gypsum. When the content of the hemihydrate gypsum is 90% or more, the addition amount of the water during the mixing may be 12-15% of the total mass of the powdered gypsum, and the total water consumption may be 27-29% of the total mass of the powdered gypsum. When the content of the hemihydrate gypsum is 95% or more, the addition amount of the water during the mixing may be 13-15% of the total mass of the powdered gypsum, and the total water consumption may be 25-28% of the total mass of the powdered gypsum.

The water is added immediately after the grinding so as to fully exert the workability of the gelling property of the hemihydrate gypsum. According to the test result, a good effect can be achieved by adding a proper amount of working water within 3 min after the grinding.

The method for preparing a hardened gypsum body provided by the present disclosure comprises: mixing the powdered gypsum, the retarder and the water to obtain a mixture, grinding the mixture, and immediately performing mechanical compression molding under a pressure of ≥10 MPa to obtain the hardened gypsum body, wherein the addition amount of the water during the mixing is 10-30% of the total mass of the powdered gypsum. Similarly, as the content of the hemihydrate gypsum in the powdered gypsum increases, the addition amount of the water during the mixing may also be gradually reduced, preferably, the addition amount of the water during the mixing is 10-24% of the total mass of the powdered gypsum.

It is found in the experiment unexpectedly in the present disclosure that after mixing and grinding the powdered gypsum, the retarder and the water, and a method of mechanical compression can also be used to activate the gelling property of the hemihydrate gypsum to form hydration reaction (i.e. no water is added). Under the process, the total water consumption for forming the hardened gypsum body is the addition amount of the water during the mixing. Compared with the mechanical compression dehydration, the key of the present disclosure lies in that firstly, the addition amount of water and its addition time are controlled, and then combined with proper mechanical pressure, such that the obtained hardened gypsum body is generally difficult-to-soften and high-strength hardened dihydrate gypsum body. The mechanical properties thereof are significantly improved under the unit water consumption.

According to the method for preparing a hardened gypsum body provided by the present disclosure, the retarder comprises one or more of sodium citrate, sodium polyphosphate, potassium tartrate, sodium acrylate, and borax;
preferably, the addition amount of the retarder accounts for 0.1-0.5% of the total mass of the powdered gypsum.

According to the method for preparing a hardened gypsum body provided by the present disclosure, the hemihydrate gypsum comprises 60% or more (by mass) of β-hemihydrate gypsum;
preferably, the hemihydrate gypsum comprises 80% or more of the β-hemihydrate gypsum; and more preferably, the hemihydrate gypsum is prepared from an industrial by-product gypsum by dehydration.

In the traditional process, compared with the β-hemihydrate gypsum, α-hemihydrate gypsum requires less water consumption, and the prepared hardened body is higher in strength and is called high-strength gypsum. The method in the present disclosure can both effectively reduce the actual water consumption required for the complete conversion of the hemihydrate gypsum to the dihydrate gypsum when using these two types of the hemihydrate gypsum. The mechanical strengths of the obtained hardened bodies are all improved to varying degrees. However, it is found in the experiment that when the proportion of the β-hemihydrate gypsum in the powdered gypsum is higher, the degree to which the water consumption can be reduced is greater, and the mechanical strength of the obtained hardened body is also significantly improved compared to the conventional process.

According to the method for preparing a hardened gypsum body provided by the present disclosure, a technical process thereof comprises:
subjecting phosphogypsum to harmless treatment to obtain powdered gypsum, wherein the harmless treatment process is a general method for removing, curing or passivating harmful substances in the phosphogypsum, and simultaneously exciting the activity of building materials of the phosphogypsum;
aging the powdered gypsum, wherein the aging is to naturally cool the anhydrous gypsum and the over-burnt gypsum generated in the harmless treatment process and then bind the material with moisture in the air sufficiently, such that the calcined material is more homogeneous and has more stable performance; and the aging time is generally more than or equal to 24 hours; and
mixing, grinding and molding the aged powdered gypsum, the retarder and the water to obtain the hardened gypsum body.

According to the method for preparing a hardened gypsum body provided by the present disclosure, a waterproof agent (such as one or more of methyl hydrogen silicone oil, methyl silicone resin, calcium stearate and zinc stearate) is further added during the mixing, preferably, the addition amount of the waterproof agent accounts for 0.1-0.5% of the total mass of the powdered gypsum;
and/or, reinforcing fibers (such as one or more of mineral fibers, glass fibers, polyvinyl alcohol fibers, polypropylene fibers and wood fibers) are further added during the mixing, preferably, the addition amount of the reinforcing fibers accounts for 0.1-0.5% of the total mass of the powdered gypsum.

According to the method for preparing a hardened gypsum body provided by the present disclosure, the particle size of the powdered gypsum is ≤50 μm. Within a certain degree range, the size is continuously reduced, which is beneficial to obtaining a more homogeneous hardened gypsum body. However, when the size of the powdered gypsum is too small, the performances of the obtained hardened gypsum body are not obviously improved, while the processing cost is greatly increased. Preferably, the particle size of the powdered gypsum is 80-200 μm.

According to the method for preparing a hardened gypsum body provided by the present disclosure, the mixing and the grinding are performed by using a stirring device and a grinding device connected with each other, preferably, a water supply device is additionally arranged on the stirring device and is used for quantitatively adding the water required during the mixing.

The mixing in the present disclosure may be performed by using a conventional stirring device, the required water is added manually or automatically, and the mixing is used for uniformly wrapping the added water around the hemihydrate gypsum molecules. Generally, the mixing time is 1-3 min. If during the stirring, small agglomerates on the surface of the mixed material are further crushed, which is more beneficial for full stirring. For example, a plurality of crushing blades are arranged in a stirring cylinder and are used for crushing the material in the cylinder.

The grinding in the present disclosure may be performed by using a conventional grinding device. The grinding device may comprise a shell, grinding disks and driving mechanisms. The driving mechanisms are used for driving the grinding disks to grind the materials. It is found in the experiment that when the grinding device with a multi-stage grinding function is used, the effect is better. After the materials pass through a grinding channel to be ground, the crystalline water first added during the mixing can more fully contact with the hemihydrate gypsum molecules.

In the process of the mixing and the grinding of the present disclosure, the particle size of the material is not changed in principle, but the occurrence of further thinning of a few molecules during the grinding impact is not excluded, and the processability of the material is good.

The present disclosure further provides a hardened gypsum body prepared by the method for preparing a hardened gypsum body as described above.

According to the hardened gypsum body provided by the present disclosure, the hardened gypsum body is a mother rock of a lightweight aggregate, a mechanically compression-molded component, a standard brick, a mechanically compression-molded module or a recycled broken stone aggregate.

Preferably, when the prepared hardened gypsum body is an aggregate product such as a lightweight aggregate with a bulk density of ≤1200 kg/m³, the cylinder compressive strength is ≥6.0 MPa, the 1-h water absorption rate is ≤7%, the softening coefficient is ≥0.85, the powder shape coefficient is ≤1.0, the boiling mass loss of harmful substances is ≤3%, the content of sulfide and sulfate is ≤0.8, the content of organic matter is less than or equal to a standard value, and the content of chloride (calculated by the content of chloride ions)/% is ≤0.01.

Wherein, granulation is a molding method in the present disclosure, does not need mechanical compression, and may be used to obtain the lightweight aggregate. The specific process may be that the ground material is added into a granulator for granulation, water is added during the granulation (namely, water is added for the second time), the addition amount of the water is calculated according to the total water consumption and the addition amount of the water during the mixing, and the material after the granulation molding is dried, screened and stored.

Besides, other structures needing mechanical compression molding may be obtained by using the process of mechanical compression molding or mechanical compression molding after the water addition for the second time according to the performance requirements.

The present disclosure further provides use of the hardened gypsum body described above.

In the method for preparing a hardened gypsum body provided by the present disclosure, the retarder and the water are added into the powdered gypsum taking the hemihydrate gypsum as the main component for mixing and grinding, the addition amount of the water during the mixing and the mixing and grinding time are controlled, such that the gypsum can keep good processing state and homogenization degree, so as to facilitate the subsequent molding process. Particularly, the water is gradually and uniformly distributed around the hemihydrate gypsum molecules to effectively reduce the total water consumption for converting the powdered gypsum into the hardened gypsum body. Besides, the mechanical properties of the obtained hardened gypsum body are significantly improved. In addition, the process parameters in the method are easy to control, and the application range is wider.

The hardened gypsum body prepared by the method for preparing a hardened gypsum body provided by the present disclosure may be prepared into various types of materials during the molding process, such as a mother rock of a lightweight aggregate, a mechanically compression-molded component of various specifications and sizes, a standard brick, a module or a recycled broken stone aggregate. Particularly, the method improves the application performance of building gypsum, and is very suitable for preparing high-strength phosphogypsum aggregate products.

### BRIEF DESCRIPTION OF THE DRAWINGS

To describe the technical solutions of the present disclosure or in the prior art more clearly, the accompanying drawings required for describing the examples or the prior art will be described briefly below. Apparently, the accompanying drawings in the following description show some examples of the present disclosure, and a person of ordinary skill in the art may still derive other drawings from these accompanying drawings without creative efforts.

FIG. 1 is the first structural schematic diagram of a device used for mixing and grinding in the present disclosure;

FIG. 2 is the second structural schematic diagram of the device used for mixing and grinding in the present disclosure; and

FIG. 3 is the third structural schematic diagram of the device used for mixing and grinding in the present disclosure.

### REFERENCE NUMBERS

1, feeding hopper; 2, stirring device; 21, stirring cylinder; 211, first cylinder body; 212, second cylinder body; 213, cover plate; 214, guiding pipe; 22, stirring assembly; 23, first driving mechanism; 231, first motor; 232, driving belt wheel; 233, driven belt wheel; 24, second driving mechanism; 3, discharging hopper; 4, grinding unit; 41, pushing cavity; 42, grinding cavity; 43, fixed grinding disk; 44, rotating grinding disk; and 45, third driving mechanism.

### DETAILED DESCRIPTION OF THE EMBODIMENTS

In order to make the objectives, technical solutions and advantages of the present disclosure clearer, the technical solutions in the present disclosure will be clearly and completely described below in conjunction with the accompanying drawings of the present disclosure. Obviously, the described examples are some, rather than all of the examples of the present disclosure. All other examples obtained by a person of ordinary skill in the art based on the examples of the present disclosure without creative efforts shall fall within the protection scope of the present disclosure.

If a specific technology or condition is not specified in the examples, it shall be one described in the literature in the art or a product specification. Reagents or instruments not specified with manufacturers are all conventional products that can be purchased through formal channels.

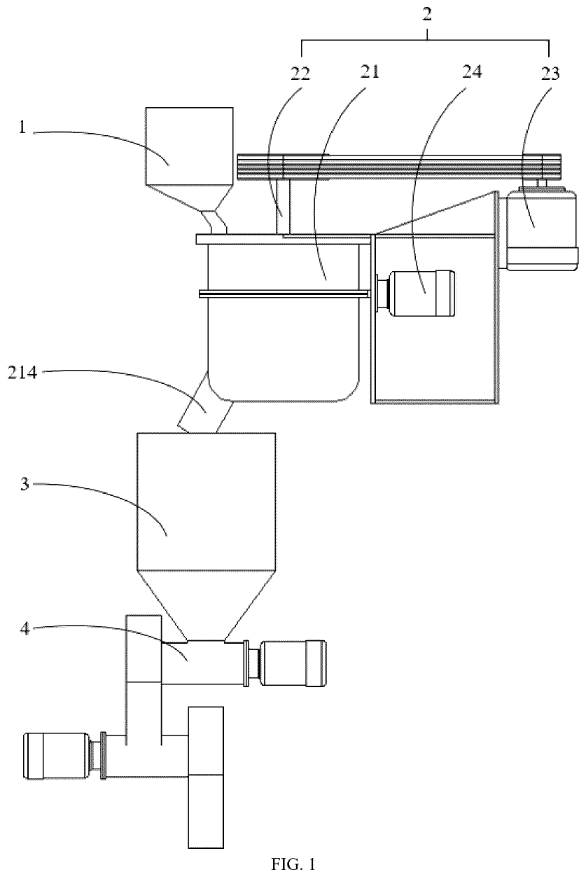

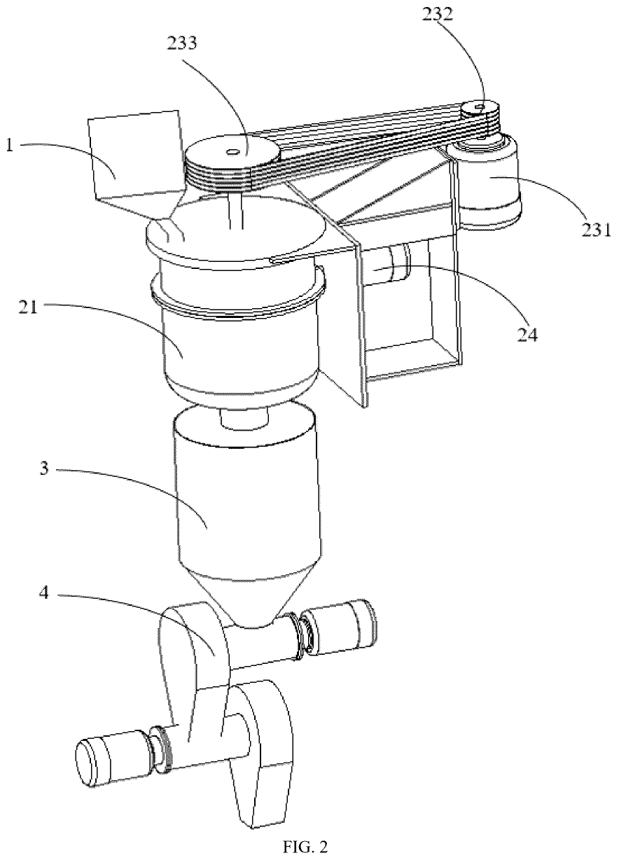

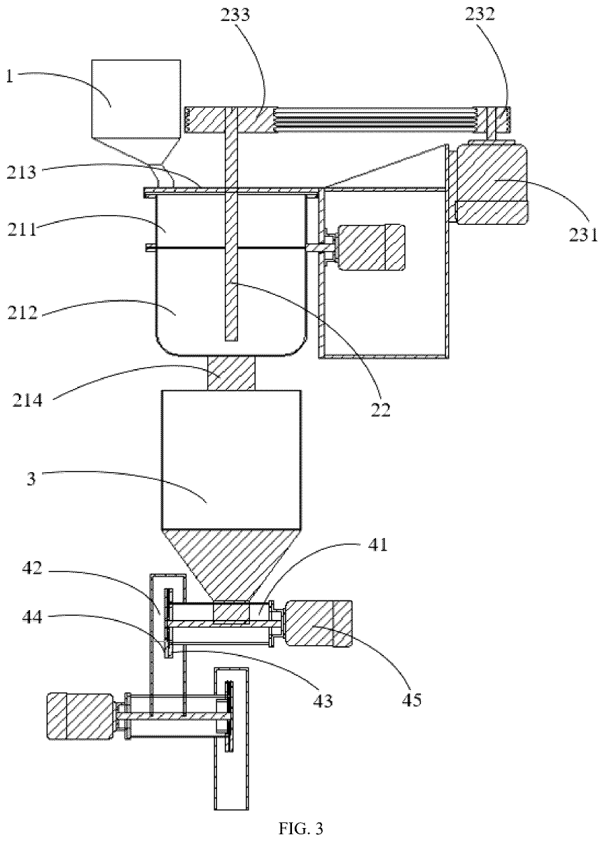

The following describes a hardened gypsum body, and a preparation method therefor and use thereof of the present disclosure in combination with FIGS. 1-3.

The device used for mixing and grinding in the present disclosure has the structure as follows:

As shown in FIGS. 1, 2 and 3, the device comprises a feeding hopper 1, a stirring device 2, a water supply device, a discharging hopper 3 and a grinding device.

The stirring device 2 is used for mixing, and comprises a stirring cylinder 21, a stirring assembly 22 and a first driving mechanism 23. The stirring assembly 22 is rotatably arranged in the stirring cylinder 21, the stirring assembly 22 comprises a stirring portion, and the stirring portion comprises a stirring shaft and stirring blades. The first driving mechanism 23 comprises a first motor 231 and a transmission assembly, and the first motor 231 is connected to the stirring assembly 22 through the transmission assembly. The transmission assembly comprises a driving belt wheel 232, a driven belt wheel 233, and a belt. The first motor 231 drives the driving belt wheel 232 to rotate, and drives the driven belt wheel 233 and the stirring assembly 22 to rotate synchronously. The discharging hopper 3, the stirring cylinder 21 and the feeding hopper 1 are sequentially arranged along the vertical direction, and the three parts communicate with each other. The stirring cylinder 21 comprises a cylinder body and a cover plate 213, a guiding pipe 214 may be arranged at the discharging port of the cylinder body, and the material in the stirring cylinder 21 flows into the discharging hopper 3 along the guiding pipe 214. A plurality of nozzles are arranged on the cover plate 213 of the stirring cylinder 21, the water supply device comprises a plurality of liquid supply pipelines, and the plurality of liquid supply pipelines are correspondingly connected with the plurality of nozzles in a one-to-one manner and used for introducing water into the stirring cylinder. One end of the stirring cylinder 21 communicates with the feeding hopper 1, and the other end of the stirring cylinder 21 communicates with the grinding device.

The grinding device is used for grinding and comprises a first grinding unit and a second grinding unit, and the two adjacent grinding units 4 communicate so as to be used for multi-stage grinding. Taking one grinding unit 4 as an example, the grinding unit 4 is provided with a pushing cavity 41 and a grinding cavity 42 communicating with each other. The pushing cavity 41 of the first grinding unit communicates with the outlet end of the discharging hopper 3, and the grinding cavity 42 of the first grinding unit communicates with the pushing cavity 41 of the second grinding unit. The grinding unit 4 comprises a shell, a fixed grinding disk 43, a rotating grinding disk 44, and a third driving mechanism 45. The shell is formed by combining a first cylindrical shell and a second fan-shaped shell, the first shell is arranged along the horizontal direction, and the second shell is arranged along the vertical direction. A partial section of the first shell are embedded into the second shell, the pushing cavity 41 is formed inside the first shell, the grinding cavity 42 is formed inside the second shell, the pushing cavity 41 and the grinding cavity 42 communicate with each other, the outlet end of the discharging hopper 3 extends into the first shell, such that the discharging hopper 3 communicates with the pushing cavity 41, and a discharging outlet is formed in the bottom of the second shell. The fixed grinding disk 43 and the rotating grinding disk 44 are both positioned in the grinding cavity 42, the fixed grinding disk 43 and the rotating grinding disk 44 are both arranged along the vertical direction, and a grinding channel is formed between the opposite surfaces of the fixed grinding disk 43 and the rotating grinding dis 44. The driving end of the third driving mechanism 45 is connected with the rotating grinding disk 44, and the third driving mechanism 45 is used for pushing the material in the pushing cavity 41 to the grinding channel and used for driving the rotating grinding disk 44 to rotate relative to the fixed grinding disk 43 so as to grind the material.

### Example 1

A method for preparing a hardened gypsum body, including the following steps:
(1) phosphogypsum was subjected to harmless treatment to obtain powdered gypsum with the particle size of 80-200 μm, wherein building gypsum accounted for 84%, anhydrous gypsum accounted for 8%, and dihydrate gypsum accounted for 4%;
(2) the powdered gypsum obtained in step (1) was aged for 24 hours; and
(3) the powdered gypsum aged in step (2), a retarder (sodium citrate) and water were mixed for 3 min and then ground for 1 min by using the mixing and grinding device described above, and the obtained mixture was immediately granulated and screened after the grinding to obtain a lightweight aggregate; wherein the water was added during the granulation, the total water consumption from the mixing to the granulation was 30% of the total mass of the powdered gypsum aged in step (2), and the mass ratio of the addition amount of the water during the mixing to the total water consumption was 18:30; and the addition amount of the retarder accounted for 0.3% of the total mass of the powdered gypsum aged in step (2).

### Example 2

The steps of a method for preparing a hardened gypsum body were substantially the same as those in example 1. The difference only lied in step (3) as follows:
(3) the powdered gypsum aged in step (2), a retarder (sodium polyphosphate) and water were mixed for 3 min and then ground for 2 min by using the mixing and grinding device described above, and the obtained mixture was immediately granulated and screened after the grinding to obtain a lightweight aggregate; wherein the water was added during the granulation, the total water consumption from the mixing to the granulation was 33% of the total mass of the powdered gypsum aged in step (2), and the mass ratio of the addition amount of the water during the mixing to the total water consumption was 20:33; and the addition amount of the retarder accounted for 0.5% of the total mass of the powdered gypsum aged in step (2).

### Example 3

The steps of a method for preparing a hardened gypsum body were substantially the same as those in example 1. The difference only lied in step (3) as follows:
(3) the powdered gypsum aged in step (2), a retarder (potassium tartrate) and water were mixed and then ground for 2 min by using the mixing and grinding device described above, and the obtained mixture was immediately granulated and screened after the grinding to obtain a lightweight aggregate; wherein the water was added during the granulation, the total water consumption from the mixing to the granulation was 28% of the total mass of the powdered gypsum aged in step (2), and the mass ratio of the addition amount of the water during the mixing to the total water consumption was 12:28; and the addition amount of the retarder accounted for 0.2% of the total mass of the powdered gypsum aged in step (2).

### Example 4

The steps of a method for preparing a hardened gypsum body were substantially the same as those in example 1. The difference only lied in step (3), in which a waterproof agent (methyl hydrogen silicone oil) was further added while a retarder was added, and the addition amount of the waterproof agent accounted for 0.3% of the total mass of the powdered gypsum aged in step (2).

### Example 5

The steps of a method for preparing a hardened gypsum body were substantially the same as those in example 1. The difference only lied in step (3), in which reinforcing fibers (glass fibers) were further added while a retarder was added, and the addition amount of the reinforcing fibers accounted for 0.3% of the total mass of the powdered gypsum aged in step (2).

### Example 6

The steps of a method for preparing a hardened gypsum body were substantially the same as those in example 4. The difference only lied in step (3), in which mineral powder was further added while a retarder and a waterproof agent were added, and the addition amount of the mineral powder accounted for 10% of the total mass of the powdered gypsum aged in step (2). The addition of the mineral powder does not significantly affect the early strength of the hardened gypsum body, but contributes to further increase the long-term strength of the hardened gypsum body.

### Example 7

The steps of a method for preparing a hardened gypsum body were substantially the same as those in example 1. The difference only lied in that the mass ratio of the addition amount of the water during the mixing to the total water consumption was 8:30.

### Comparative Example 1

The steps of a method for preparing a hardened gypsum body were substantially the same as those in example 1. The difference only lied in that the grinding time was prolonged to 7 min.

The hardened gypsum bodies prepared in examples 1-7 and comparative examples 1-2 were tested. The test results were as follows:

| | | 24-h cylinder | Water | Softening |
|---|---|---|---|---|
| | Density | compressive | absorption | coefficient |
| | (kg/m³) | strength (MPa) | rate (%) | (%) |
| Example 1 | 950 | 10.0 | 6.8 | 85.8 |
| Example 2 | 10.5 | 8.0 | 6.5 | 83.1 |
| Example 3 | 950 | 6.9 | 5.8 | 80.8 |
| Example 4 | 960 | 11.5 | 4.7 | 93.1 |
| Example 5 | 1030 | 13.0 | 4.5 | 95.4 |
| Example 6 | 1080 | 8.0 | 7.5 | 78.2 |
| Example 7 | 960 | 9.2 | 7.5 | 81.4 |
| Comparative | 950 | 6.0 | 10.0 | 50.1 |
| example 1 | | | | |

### Example 8

A method for preparing a hardened gypsum body, including the following steps:
(1) the step was the same as that in example 1;
(2) the step was the same as that in example 1; and
(3) the powdered gypsum aged in step (2), a retarder (sodium citrate), a waterproof agent (methyl hydrogen silicone oil), reinforcing fibers (glass fibers) and water were mixed for 3 min and then ground for 1 min by using the mixing and grinding device described above, and the obtained mixture was immediately put into a mold to be subjected to mechanical compression molding at the pressure of 10 MPa to obtain a standard brick, wherein the addition amount of the water during the mixing was 27% of the total mass of the powdered gypsum; and addition amount of the retarder, the waterproof agent and the reinforcing fibers each accounted for 0.3% of the total mass of the powdered gypsum aged in step (2).

### Example 9

The steps of a method for preparing a hardened gypsum body were substantially the same as those in example 8. The difference only lied in that the pressure of the mechanical compression was adjusted to 15 MPa.

### Example 10

The steps of a method for preparing a hardened gypsum body were substantially the same as those in example 8. The difference only lied in that the pressure of the mechanical compression was adjusted to 20 MPa.

### Example 11

The steps of a method for preparing a hardened gypsum body were substantially the same as those in example 8. The difference only lied in that the pressure of the mechanical compression was adjusted to 25 MPa.

### Example 12

The steps of a method for preparing a hardened gypsum body were substantially the same as those in example 8. The difference only lied in that the addition amount of water during the mixing was adjusted to 30% of the total mass of the powdered gypsum, and the pressure of the mechanical compression was adjusted to 30 Mpa.

### Comparative Example 2

The steps of a method for preparing a hardened gypsum body were substantially the same as those in example 8. The difference only lied in that the grinding time was prolonged to 5 min.

### Comparative Example 3

The steps of a method for preparing a hardened gypsum body were substantially the same as those in example 8. The difference only lied in that the addition amount of water during the mixing was adjusted to 33% of the total mass of the powdered gypsum.

The hardened gypsum bodies prepared in examples 8-12 and comparative examples 2-3 were tested. The test results were as follows:

| | | 24-h | Water | Softening |
|---|---|---|---|---|
| | Density | compressive | absorption | coefficient |
| | (kg/m³) | strength (MPa) | rate (%) | (%) |
| Example 8 | 1100 | 12.0 | 8.0 | 85.7 |
| Example 9 | 1350 | 18.0 | 4.0 | 90.3 |
| Example 10 | 1750 | 25.0 | 2.0 | 93.8 |
| Example 11 | 1950 | 35.0 | 1.5 | 96.4 |
| Example 12 | 2250 | 45.0 | 0.8 | 98.5 |
| Comparative | 1060 | 5.8 | 12.7 | 58.8 |
| example 2 | | | | |
| Comparative | 1140 | 9.0 | 8.4 | 80.4 |
| example 3 | | | | |

Finally, it should be noted that the foregoing examples only used to illustrate the technical solutions of the present disclosure, and are not intended to limit same. Although the present disclosure is described in detail with reference to the foregoing examples, a person of ordinary skill in the art should understand that they can still modify the technical solutions described in the foregoing examples, or make equivalent substitutions to some technical features therein. These modifications or substitutions do not make the essence of the corresponding technical solutions depart from the spirit and scope of the technical solutions of the examples of the present disclosure.

### INDUSTRIAL APPLICABILITY

The present disclosure provides a hardened gypsum body, and a preparation method therefor and use thereof. The method comprises mixing powdered gypsum, a retarder and water to obtain a mixture, grinding the mixture, and immediately molding same after the grinding to obtain the hardened gypsum body, wherein the total time of the mixing and the grinding is 2-5 min, and the addition amount of the water during the mixing is 8-30% of the total mass of the powdered gypsum. The hardened gypsum body prepared by the method has significantly improved mechanical properties and low porosity, and can be used for preparing a mother rock of a lightweight aggregate, a mechanically compression-molded component, a mechanically compression-molded module or a recycled broken stone aggregate. The method greatly expands the application range of the hardened gypsum body, particularly improves the application performance of building gypsum, is very suitable for preparing high-strength phosphogypsum aggregate products, and has good economic value and application prospects.

1. A method for preparing a hardened gypsum body, comprising: mixing powdered gypsum containing hemihydrate gypsum with a mass content of 60% or more and dihydrate gypsum with a content of less than or equal to 5%, a retarder and water to obtain a mixture, grinding the mixture, and immediately molding same after the grinding to obtain the hardened gypsum body, wherein the total time of the mixing and the grinding is 2-5 min, and the addition amount of the water during the mixing is 8-30% of the total mass of the powdered gypsum.

2. The method for preparing a hardened gypsum body according to claim 1, comprising: mixing the powdered gypsum, the retarder and the water to obtain the mixture, grinding the mixture, and immediately adding water for molding to obtain the hardened gypsum body, wherein the addition amount of the water during the mixing is 8-22% of the total mass of the powdered gypsum, and the total water consumption from the mixing to the molding is 27-33% of the total mass of the powdered gypsum.

3. The method for preparing a hardened gypsum body according to claim 1, comprising: mixing the powdered gypsum, the retarder and the water to obtain the mixture, grinding the mixture, and immediately performing mechanical compression molding under a pressure of ≥10 MPa to obtain the hardened gypsum body, wherein the addition amount of the water during the mixing is 10-30% of the total mass of the powdered gypsum.

4. The method for preparing a hardened gypsum body according to claim 1, wherein the retarder comprises one or more of sodium citrate, sodium polyphosphate, potassium tartrate, sodium acrylate, and borax.

5. The method for preparing a hardened gypsum body according to claim 4, wherein the addition amount of the retarder accounts for 0.1-0.5% of the total mass of the powdered gypsum.

6. The method for preparing a hardened gypsum body according to claim 1, wherein the hemihydrate gypsum comprises 60% or more of β-hemihydrate gypsum.

7. The method for preparing a hardened gypsum body according to claim 6, wherein the hemihydrate gypsum comprises 80% or more of the β-hemihydrate gypsum.

8. The method for preparing a hardened gypsum body according to claim 1, wherein a technical process thereof comprises:
subjecting phosphogypsum or other industrial by-product gypsum to harmless treatment to obtain powdered gypsum;
aging the powdered gypsum; and
mixing, grinding and molding the aged powdered gypsum, the retarder and the water to obtain the hardened gypsum body.

9. The method for preparing a hardened gypsum body according to claim 1, wherein a waterproof agent is further added during the mixing;
and/or, reinforcing fibers are further added during the mixing.

10. The method for preparing a hardened gypsum body according to claim 9, wherein the addition amount of the waterproof agent accounts for 0.1-0.5% of the total mass of the powdered gypsum, and the addition amount of the reinforcing fibers accounts for 0.1-0.5% of the total mass of the powdered gypsum.

11. The method for preparing a hardened gypsum body according to claim 1, wherein the particle size of the powdered gypsum is ≤50 μm.

12. The method for preparing a hardened gypsum body according to claim 1, wherein the mixing and the grinding are performed by using a stirring device and a grinding device connected with each other.

13. The method for preparing a hardened gypsum body according to claim 12, wherein a water supply device is additionally arranged on the stirring device and is used for quantitatively adding the water required during the mixing.

14. A hardened gypsum body prepared by the method for preparing a hardened gypsum body according to claim 1.

15. The hardened gypsum body according to claim 14, wherein the hardened gypsum body is a mother rock of a lightweight aggregate, a mechanically compression-molded component, a standard brick, a mechanically compression-molded module or a recycled broken stone aggregate.

16. Use of the hardened gypsum body according to claim 14.
